(19) United States
(12) Patent Application Publication
(10) Pub. No.: US 2009/0124297 A1
(43) Pub. Date: May 14, 2009

(54) MOBILE PHONE AND COMMUNICATION METHOD OF THE SAME

(75) Inventors: Fang-Hua LIU, Shenzhen City (CN); Shih-Fang WONG, Tu-Cheng (TW); Xin LU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/241,094

(22) Filed: Sep. 30, 2008

(30) Foreign Application Priority Data
Nov. 13, 2007 (CN) 200710202506.0

(51) Int. Cl. H04M 1/00

(52) U.S. Cl. 455/572; 455/550.1

(57) ABSTRACT

A mobile phone is designed for sending predetermined messages to the owner's relatives and friends according to phone numbers recorded therein after the mobile phone is stolen. The mobile phone includes a memory, a communication module, and a microprocessor. The memory is for storing phone numbers and predetermined messages. The communication module is for sending information wirelessly. The microprocessor is for reading the phones numbers and sending the predetermined messages according to the phone numbers when the mobile phone is stolen. A communication method used by the mobile phone is also provided.

### BACKGROUND

1. Field of the Disclosure

The present disclosure generally relates to mobile phones, and more particularly to a mobile phone and a communication method thereof.

2. Description of Related Art

Mobile phones are popularly used in society for their small sizes and portable features. However, for the same reasons, the mobile phones are easy to be stolen. And what is worse, the stolen mobile phones might be used to defraud persons whose contacts are listed in the stolen mobile phones.

Therefore, a mobile phone having a security mechanism is needed in the industry to address the aforementioned deficiency.

### SUMMARY

A mobile phone is designed for sending predetermined messages to the owner's relatives or friends according to phone numbers recorded therein after the mobile phone is stolen. The mobile phone includes a memory, a communication module, and a microprocessor. The memory is for storing phone numbers and predetermined messages. The communication module is for sending information wirelessly. The microprocessor is for reading the phone numbers and sending the predetermined messages according to the phone numbers when the mobile phone is stolen. A communication method used by the mobile phone is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a block diagram showing a mobile phone in accordance with an exemplary embodiment, and the mobile phone includes a microprocessor and a power manager.

FIG. 2 is a block diagram showing the power manager of FIG. 1.

FIG. 3 is a block diagram showing the microprocessor of FIG. 1.

FIG. 4 is a flowchart showing a communication method for sending predetermined messages according to phone numbers stored in the mobile phone of FIG. 1.

FIG. 5 is a flowchart showing steps for judging whether the mobile phone is stolen in accordance with a first embodiment.

FIG. 6 is a flowchart showing steps for judging whether the mobile phone is stolen in accordance with a second embodiment.

### DETAILED DESCRIPTION

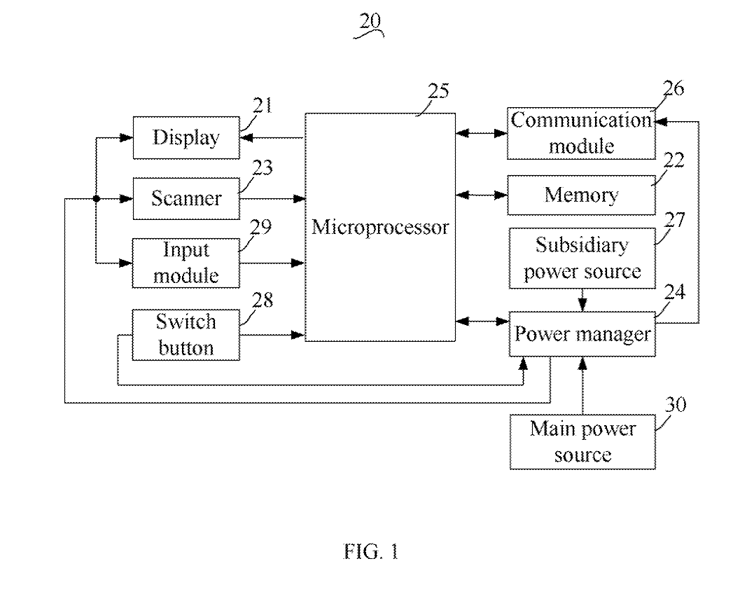

Referring to FIG. 1, a mobile phone 20, in accordance with an exemplary embodiment, is configured to send predetermined messages to contacts listed in the mobile phone upon being stolen.

The mobile phone 20 includes a display 21, a memory 22, a scanner 23, a power manager 24, a microprocessor 25, a communication module 26, a subsidiary power source 27, a switch button 28, an input module 29, and a main power source 30. The power manager 24 is directly connected to all of the other components except the memory 22. The microprocessor 25 is directly connected to all of the other components except the subsidiary power source 27 and the main power source 30. In the embodiment, the main power source 30 is a detachable battery, and the subsidiary power source 27 is permanently fixed inside the mobile phone 20. In practice, the scanner 23 is fixed on top of the switch button 28.

The display 21 is for displaying information of the mobile phone 20. The memory 22 is for storing predetermined fingerprint data, the phone numbers of contacts, and the predetermined messages. The scanner 23 is for scanning a fingerprint of a current operator of the mobile phone; the current operator, may be the predetermined operator such as the owner or a legitimate user, or an unauthorized operator, such as an illegitimate operator, or a malicious operator. The scanner 23 is further for generating a current operator fingerprint scan. The power manager 24 is for selectively drawing power between the subsidiary power source 27 and the main power source 30. The microprocessor 25 is for controlling the other components. The communication module 26 is for sending the predetermined messages to the contacts listed in the mobile phone. The switch button 28 can be pressed, and, when actuated, generates a switch signal that is sent to the microprocessor 25. In practice, the switch button 28 is configured for powering on and powering off the mobile phone 20. The input module 29 is used for inputting information of the contacts and the predetermined messages.

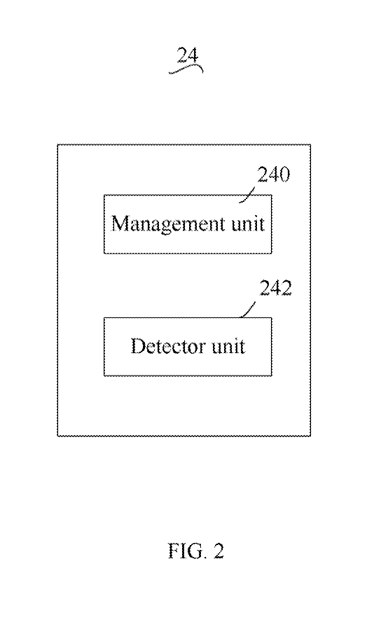

Also referring to FIG. 2, the power manager 24 includes a management unit 240 and a detector unit 242. The detector unit 242 is for detecting states of the subsidiary power source 27 and the main power source 30. The management unit 240 is for selectively drawing the power between the subsidiary power source 27 and the main power source 30.

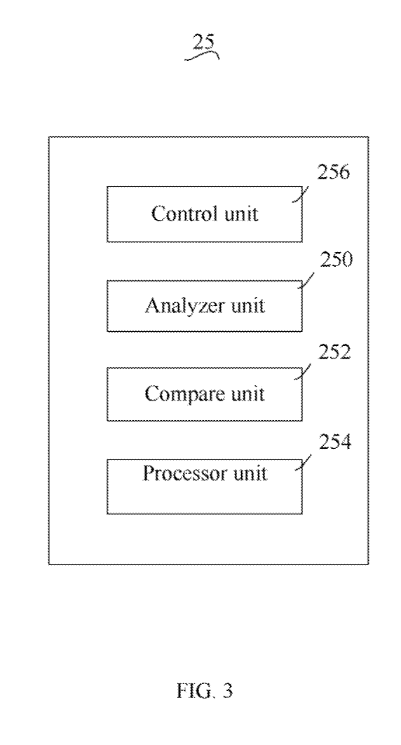

Further referring to FIG. 3, the microprocessor 25 includes an analyzer unit 250, a compare unit 252, a processor unit 254, and a controller unit 256. The analyzer unit 250 is for analyzing the fingerprint scan and generating corresponding fingerprint data. The compare unit 252 is for comparing the fingerprint data with the predetermined fingerprint data. The processor unit 254 is for reading the phone numbers of the contacts and the predetermined messages from the memory 22, and sending the phone numbers and the predetermined messages to the communication module 26. The controller unit 256 is for receiving the switch signal and controlling the management unit 240 of the power manager 24 based on the switch signal. In the embodiment, the processor unit 254 is also used for receiving the phone numbers and the predetermined messages inputted via the input module 29, and storing the phone numbers and the predetermined messages into the memory 22.

In a condition that the mobile phone 20 is stolen or lost, the illegitimate operator would be using the mobile phone 20, and would have to actuate the switch button 28 to power off the mobile phone 20. The scanner 23 fixed on top of the switch button 28 scans a fingerprint of the current operator, generates the current operator fingerprint scan, and sends the current operator fingerprint scan to the microprocessor 25. Simultaneously, the switch button 28 generates a switch signal and sends the switch signal to the microprocessor 25. Because the illegitimate user's fingerprint does not match an authentic fingerprint stored in the phone, the authentication would fail. As a result, the controller unit 256 receives the switch signal and signals the power manager 24 to power off the display 21, and the illegitimate operator would not know that the mobile phone 20 is still operating. In the authentication process, the analyzer unit 250 analyzes the current operator fingerprint scan and generates fingerprint data. The compare unit 252 compares the fingerprint data with the predetermined fingerprint data. If the compared result is a valid result, the controller unit 256 signals the power manager 24 to stop supplying power, in order to power off the whole phone. If the compared result is an invalid result, the processor unit 254 reads the phone numbers and the predetermined messages from the memory 22, and sends them to the communication module 26. The communication module 26 automatically sends the predetermined messages to the phone numbers of the contacts. Herein, the valid result indicates that the fingerprint data is substantially the same as the predetermined fingerprint data. The invalid result indicates that the fingerprint data is different from the predetermined fingerprint data.

In another case, the unauthorized user may directly detach the main power source 30, for example a battery. The detector unit 242 of the power manager 24 would instantly detect a sudden disconnection of the main power source 30. The management unit 240 alternatively draws power from the subsidiary power source 27, and supplies power only to the microprocessor 25 and the communication module 26. The processor unit 254 reads the phone numbers and the predetermined messages from the memory 22, and sends them to the communication module 26. The communication module 26 automatically sends the predetermined messages to the phone numbers of the contacts.

As mentioned above, no matter whether the illegitimate operator actuates the switch button 28 to power off the mobile phone 20 or detaches the main power source 30, the communication module 26 automatically sends the predetermined messages to the contacts, such as the owner's relatives and friends, according to the phone numbers stored in the memory 22. Therefore, contacts of the phone are alerted, thereby can avoid being defrauded from the illegitimate operator.

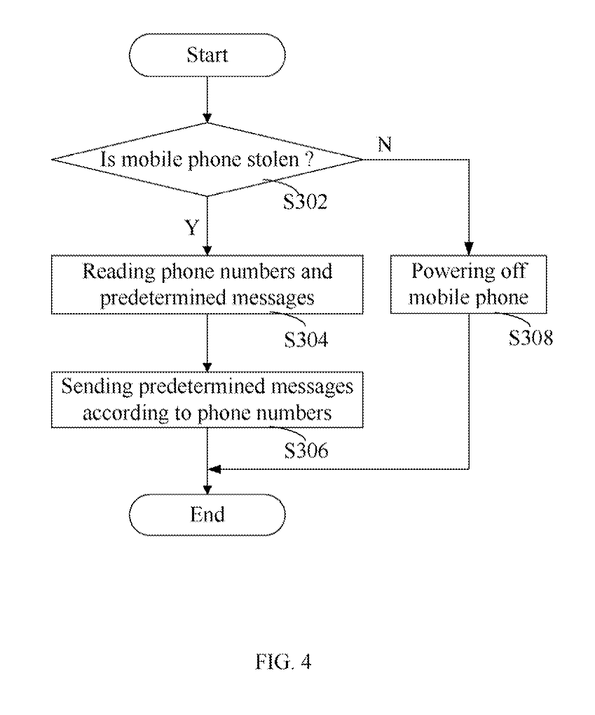

Further referring to FIG. 4, a communication method in accordance with an exemplary embodiment is used by the mobile phone 20 to send predetermined messages to the contacts stored in the mobile phone 20. A procedure of the communication method is described in the following steps.

In step S302, the mobile phone 20 automatically judges whether it is stolen. If the mobile phone 20 is stolen, the procedure goes to step S304. If the mobile phone 20 is not stolen, the procedure goes to step S308. Step S302 will be described in detail hereinafter.

In step S304, the processor unit 254 reads the phone numbers and the predetermined messages from the memory 22.

In step S306, the communication module 26 automatically sends the predetermined messages to the phone numbers of the contacts.

In step S308, the controller unit 256 signals the power manager 24 to stop supplying power. That is, the power manager 24 powers off the mobile phone 20.

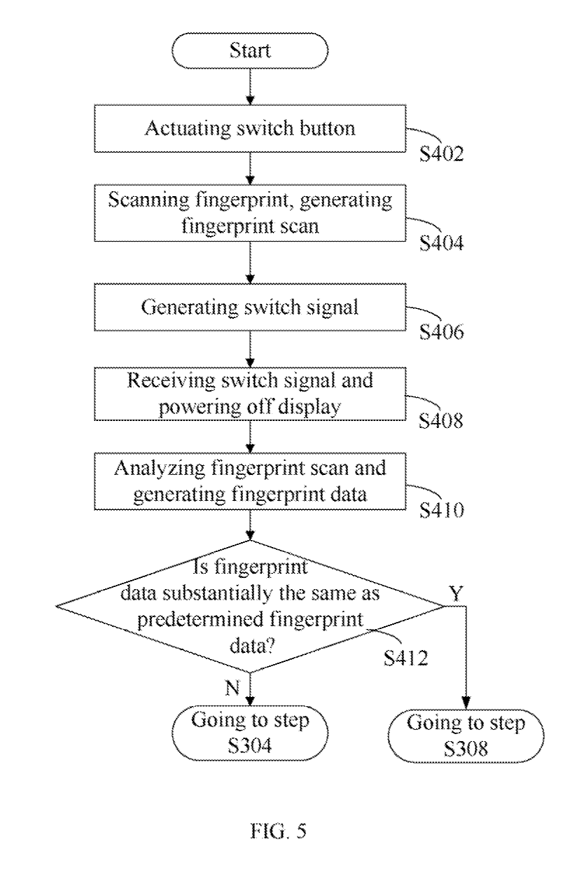

Also referring to FIG. 5, a first embodiment of aforementioned step S302 for judging whether the mobile phone 20 is being used by an illegitimate operator is described in the following detailed sub-steps.

In sub-step S402, the switch button 28 is actuated when the mobile phone 20 is in standby mode.

In sub-step S404, the scanner 23 fixed on top of the switch button 28 scans the current operator fingerprint, and generates a current operator fingerprint scan according to the current operator fingerprint.

In sub-step S406, the switch button 28 generates the switch signal and sends the switch signal to the microprocessor 25.

In sub-step S408, the controller unit 256 receives the switch signal and signals the power manager 24 to power off the display 21.

In sub-step S410, the analyzer unit 250 analyzes the current operator fingerprint scan and generates fingerprint data.

In sub-step S412, the compare unit 252 compares the fingerprint data with the predetermined fingerprint data. If the compare result is a valid result, the procedure goes to step S308. If the compare result is an invalid result, the procedure goes to step S304.

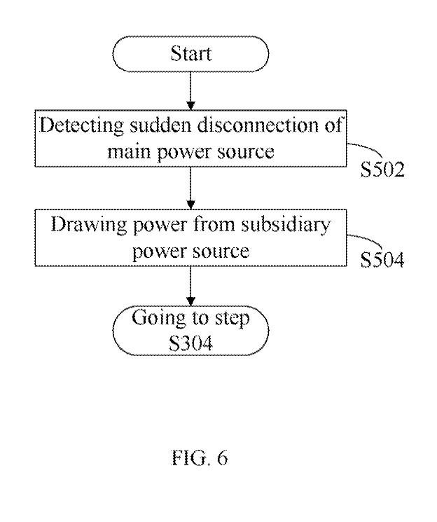

Also referring to FIG. 6, a second embodiment of aforementioned step S302 is described in the following detailed sub-steps.

In sub-step S502, the detector unit 242 detects a sudden disconnection of the main power source 30 when the main power source 30 is detached. In sub-step S504, the management unit 240 draws power from the subsidiary power source 27. After that, the procedure goes to step S304.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile phone comprising:
a memory for storing phone numbers and predetermined messages;
a communication module capable of sending information wirelessly; and
a microprocessor capable of reading the phones numbers and sending the predetermined messages according to the phone numbers when the mobile phone is stolen.

2. The mobile phone according to claim 1, further comprising a scanner for scanning a fingerprint and generating a fingerprint scan.

3. The mobile phone according to claim 2, wherein the microprocessor comprises an analyzer unit for analyzing the fingerprint scan and generating fingerprint data corresponding to the fingerprint scan.

4. The mobile phone according to claim 3, wherein the memory further stores predetermined fingerprint data, and the microprocessor further comprises a compare unit for comparing the fingerprint data with the predetermined fingerprint data.

5. The mobile phone according to claim 4, wherein the microprocessor comprises a processor unit for reading the phone numbers and the predetermined messages from the memory, and sending them to the communication module when the fingerprint data is compared to be the same as the predetermined fingerprint data.

6. The mobile phone according to claim 1, further comprising a main power source detachably received in the mobile phone and a subsidiary power source fixed in the mobile phone.

7. The mobile phone according to claim 6, further comprising a power manager directly connected to the main power source and the subsidiary power source, and is capable of selecting power supply from the main power source and the subsidiary power source.

8. The mobile phone according to claim 7, wherein the power manager comprises a detector for detecting states of the main power source and the subsidiary power source and a management unit for distributing the power according to the detected states.

9. The mobile phone according to claim 8, further comprising a switch button directly connected to the microprocessor, wherein when the switch button is actuated the microprocessor signals the power manager to stop distributing the power.

10. The mobile phone according to claim 9, further comprising a scanner fixed on top of the switch button for scanning a fingerprint when the switch button is actuated.

11. The mobile phone according to claim 1, further comprising an input module for inputting the phone numbers and the predetermined messages.

12. A communication method used in powering off a mobile phone, the communication method comprising:
judging whether the mobile phone is stolen;
reading phone numbers and predetermined messages stored in the mobile phone if the mobile phone is stolen;
sending the predetermined messages according to phone numbers; and
powering off the mobile phone if the mobile phone is not stolen.

13. The communication method according to claim 12, further comprising:
actuating a switch button of the mobile phone when the mobile is in standby mode;
scanning a fingerprint, and generating a fingerprint scan according to the fingerprint;
generating a switch signal; and
stopping displaying according to the switch signal.

14. The communication method according to claim 13, further comprising:
analyzing the fingerprint scan and generating fingerprint data;
comparing the fingerprint data with predetermined fingerprint data stored in the mobile phone;
going to “reading phone numbers and predetermined messages stored in the mobile phone if the mobile phone is stolen” step if the fingerprint data is substantially the same as the predetermined fingerprint data; and
going to “powering off the mobile phone if the mobile phone is not stolen” if the fingerprint data is different from the predetermined fingerprint data.

15. The communication method according to claim 12, further comprising:
drawing power from a subsidiary power source of the mobile phone upon a condition that a sudden disconnection from the main power source;
going to “reading phone numbers and predetermined messages stored in the mobile phone if the mobile phone is stolen”.
